(19) United States
(12) Patent Application Publication
(10) Pub. No.: US 2025/0199783 A1
(43) Pub. Date: Jun. 19, 2025

(54) METHOD, PROCESSOR AND PROGRAM STORAGE MEDIUM FOR SOLVING BIT PADDING PROBLEM WHEN CREATING A VIRTUAL CONTROLLER

(71) Applicant: HYUNDAI AUTOEVER CORP., Seoul (KR)

(72) Inventors: Kyung Nam Kim, Seoul (KR); Sung Hoon Woo, Seoul (KR); Min Soo Kim, Seoul (KR)

(73) Assignee: HYUNDAI AUTOEVER CORP., Seoul (KR)

(21) Appl. No.: 18/975,334

(22) Filed: Dec. 10, 2024

(30) Foreign Application Priority Data
Dec. 13, 2023 (KR) 10-2023-0180778

(51) Int. Cl. G06F 8/41

(52) U.S. Cl. CPC G06F 8/434

(57) ABSTRACT

A method, processor, and program storage medium for solving a bit padding problem when creating a virtual controller are provided. In particular, a technique of allowing a virtual controller to work properly in any environment is provided. The technique may include changing the size of a structure in a source code and splitting a variable in order to prevent abnormal operation of the virtual controller that may be caused by bit padding.

### CROSS REFERENCE TO RELATED APPLICATION

This application claims the benefit of and priority to Korea Patent Application No. 10-2023-0180778, filed on Dec. 13, 2023, the entire contents of which are hereby incorporated herein by reference.

### FIELD OF TECHNOLOGY

The present disclosure relates to a method, processor, and storage medium for solving a bit padding problem when creating a virtual controller.

### BACKGROUND

Source code refers to plain text code used in writing a computer program. Typically, source code, which is a set of instructions written in a programming language, is a form of code that can be understood and written by humans. Source code includes grammars and rules for giving instructions to a computer.

A variable is a space in memory with a name that is used to store and manage data used in a program. A variable may be used to store, reference, or manipulate data. A variable can store different types of data, such as numbers, text, and objects. The value of the variable may change with the size of data stored.

A structure refers to a concept used in combining a number of variables together to define a single new data type in programming languages. By means of a structure, variables of different data types can be grouped together and managed as a single unit.

A bit field refers to a structure that has bits as members.

Variables included in a structure are placed consecutively in memory, and may have a certain value depending on the data type of each variable and the basic alignment strategy of a compiler. However, there are instances of changing the values of variables or adjust the alignment of variables in order to adjust the size of the structure and optimize memory usage.

In cases where there is some remaining space when storing data in memory, additional bits may be inserted into the memory to fill the remaining space, which can be called bit padding.

A virtual controller refers to a control system that is implemented in software in a computer system or a simulation environment, rather than in actual hardware. Such a virtual controller may replace or imitate actual physical hardware to control a particular task or process and be used in simulations or the like.

Such a virtual controller may be created through a process of building source code. However, in the process of building source code, the occurrence of bit padding may depend on which build tool is used, and accordingly, the virtual controller may not work properly.

### SUMMARY

An aspect of the present disclosure is to provide a technique capable of creating a virtual controller that works properly in any environment.

Another aspect of the present disclosure is to provide a technique capable of preventing bit padding caused by variables in a structure.

Yet another aspect of the present disclosure is to provide a technique that is applicable to a CAN DB (controller area network database).

According to an embodiment of the present disclosure, a method is provided. The method includes checking for whether bit padding occurs when compiling source code including a structure containing one or more variables. The method also includes, when an occurrence of bit padding is verified, splitting a bit-padded variable in the source code.

Splitting the bit-padded variable may include splitting the bit-padded variable so that there is no blank in memory.

Split bit-padded variables may be packed into one variable.

The method may further include compiling and linking the source code subjected to the splitting and creating a virtual controller.

The virtual controller may be a virtual model of an ECU (electronic controller unit).

According to an embodiment of the present disclosure, another method is provided. The method includes checking for whether bit padding occurs when compiling source code including a structure containing one or more variables. The method also includes, when an occurrence of bit padding is verified, changing a maximum number of bytes in the structure. The method further includes checking for whether bit padding occurs in the source code in which the maximum number of bytes in the structure is changed. The method additionally includes, when an occurrence of bit padding is verified, splitting a bit-padded variable in the source code in which the maximum number of bytes in a structure declaration is changed.

Splitting the bit-padded variable may include splitting the bit-padded variable so that there is no blank in memory.

The method may further include compiling and linking the source code subjected to the splitting and creating a virtual controller.

The virtual controller may be a virtual model of an ECU (electronic controller unit).

Changing the maximum number of bytes may include increasing the maximum number of bytes.

Split bit-padded variables may be packed into one variable.

According to yet an embodiment of the present disclosure, a computer-readable storage medium storing a program is provided. The program, when executed by a processor, causes the processor to: check for whether bit padding occurs when compiling source code including a structure containing one or more variables; when an occurrence of bit padding is verified, change a maximum number of bytes in the structure; check for whether bit padding occurs in the source code in which the maximum number of bytes in the structure is changed; and, when an occurrence of bit padding is verified, split a bit-padded variable in the source code in which the maximum number of bytes in a structure declaration is changed.

The program, when executed by a processors, may cause the processor to split the bit-padded variable so that there is no blank in memory.

The program, when executed by a processors, may further cause the processor to compile and link the source code subjected to the splitting and creating a virtual controller.

The virtual controller may be a virtual model of an ECU (electronic controller unit).

The program, when executed by a processors, may cause the processor to change the maximum number of bytes by increasing the maximum number of bytes.

Split bit-padded variables may be packed into one variable.

According to a further embodiment of the present disclosure, a processor is provided. The processor includes a checking part configured to check for whether bit padding occurs when compiling source code including a structure containing one or more variables. The processor also includes a processing part configured to perform one or more of changing the maximum number of bytes in the structure or splitting a bit-padded variable among the one or more variables when bit padding occurs.

The processor part may be configured to split the bit-padded variable so that there is no blank in memory.

The processor may be configured to change the maximum number of bytes by increasing the maximum number of bytes

According to further embodiment of the present disclosure, another method is provided. The method includes checking for whether bit padding occurs when compiling source code including one or more bit field declarations, and the method also includes, when an occurrence of bit padding is verified, splitting bits, where bit padding occurs, in the bit field.

Splitting the bits may include splitting the bits, where bit padding occurs, so that there is no blank in memory.

Split bits, where bit padding occurs, may be packed into one variable.

The method may further include compiling and linking the split source code and creating a virtual controller.

The virtual controller may be a virtual model of an ECU (electronic controller unit).

As described above, according to embodiments of the present disclosure, it is possible to create a virtual controller that works properly in any environment.

According to embodiments of the present disclosure, it is also possible to prevent abnormal operation of a virtual controller that may be caused by bit padding.

Furthermore, according to embodiments of the present disclosure, it is possible to solve problems caused by bit padding in a highly stable and compatible manner.

### BRIEF DESCRIPTION OF THE DRAWINGS

FIG. 1 is a view for explaining a virtual controller creation process according to an embodiment of the present disclosure.

FIG. 2 is a view for explaining a build process according to an embodiment of the present disclosure.

FIG. 3 is a view for explaining a method for solving a bit padding problem according to a first embodiment of the present disclosure.

FIG. 4 is a view for explaining a method for solving a bit padding problem according to a second embodiment of the present disclosure.

FIGS. 5-7 are diagrams of examples for explaining bit padding according to embodiments of the present disclosure.

FIG. 8 is a diagram showing implementation of a method for solving a bit padding problem according to a second embodiment of the present disclosure.

FIG. 9 is a view for explaining a processor performing a method for solving a bit padding problem according to an embodiment of the present disclosure.

### DETAILED DESCRIPTION

Hereinafter, embodiments of the present disclosure are described in detail with reference to the accompanying drawings. With regard to the reference numerals of the components of the respective drawings, it should be noted that the same reference numerals are assigned to the same components even when the components are shown in different drawings. In addition, in describing the present disclosure, detailed descriptions of well-known configurations or functions have been omitted in order to not obscure the gist of the present disclosure.

In addition, terms such as “first”, “second”, “A”, “B”, “(a)”, “(b)”, or the like may be used in describing the components of the present disclosure. These terms are intended only for distinguishing a corresponding component from other components, and the nature, order, or sequence of the corresponding component is not limited to the terms. In the case where a component is described as being “coupled”, “combined”, or “connected” to another component, it should be understood that the corresponding component may be directly coupled or connected to another component or that the corresponding component may also be “coupled”, “combined”, or “connected” to the component via another component provided therebetween.

In addition, in the present specification, the terms such as “module,” “part,” “device,” etc. may be intended to refer to hardware or a functional or structural combination of software driven by corresponding hardware or for driving hardware. For example, hardware herein may be a data processing device including a central processing unit (CPU) or another processor. In addition, software driven by hardware may refer to a running process, an object, an executable, a thread of execution, a program, etc.

When a component, device, module, element, or the like of the present disclosure is described as having a purpose or performing an operation, function, or the like, the component, device, or element should be considered herein as being “configured to” meet that purpose or perform that operation or function.

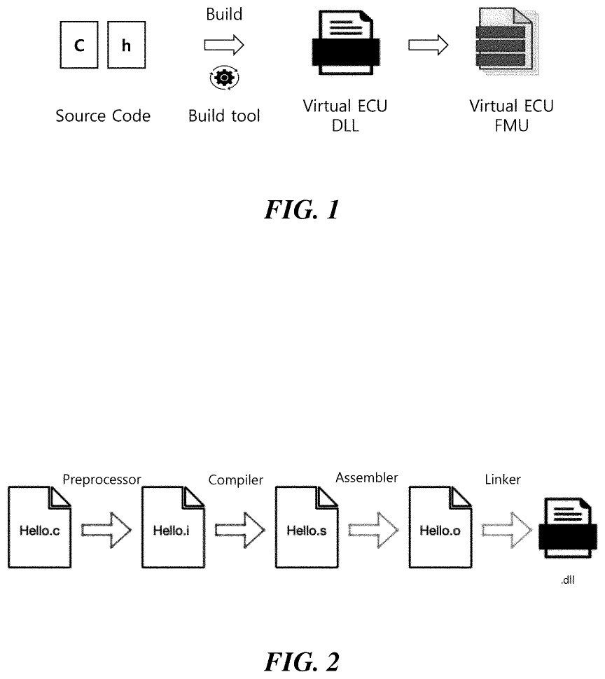

FIG. 1 is a view for explaining a virtual controller creation process according to an embodiment of the present disclosure.

Referring to FIG. 1, a virtual controller may be created by using written source code.

Specifically, source code may be written in a variety of programming languages. The source code may include various variables and various structures including various variables.

Moreover, the source code may include a bit field containing one or more bits.

In addition, the source code may include grammars and rules for giving instructions to a computer.

Such source code may be built by a build tool. Here, the term build may refer to a process in which source code is converted into software, library, etc. that can be executed by a computer. The term build tool may refer to software used to compile or build source code.

Source code may be built and converted into a virtual controller file. Here, the virtual controller may be a vECU (virtual electronic controller unit) which is a virtual model of an ECU (electronic controller unit).

DLL is an abbreviation for Dynamic Link Library, and a vECU may create a DLL file as an FMU (functional mock-up unit) file using an FMI (functional mock-up interface).

As an example, a virtual controller may be applied in the developmental stage of automotive software. The virtual controller may construct a hardware-independent development environment. The virtual controller may be used in logic verification. The virtual controller may be used as a simulation tool.

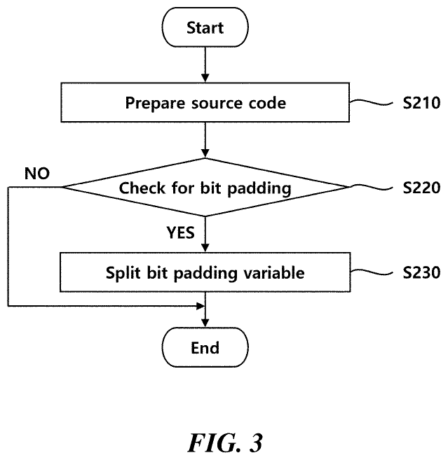

FIG. 2 is a view for explaining a build process according to an embodiment of the present disclosure.

Referring to FIG. 2, written source code may be preprocessed by a preprocessor. Here, the preprocessing may refer to a process in which additional processing is performed on source code before the source code is compiled by a compiler.

In the preprocessing step, macro extensions, insertion of header files, conditional compilation, use of preprocessor directive, and so on may be performed.

Preprocessed source code may be compiled by a compiler.

Here, the compilation may refer to the process of converting source code into assembly code or the process of translating source code into a machine language that can be understood by a computer. Software that performs compilations may be called a compiler.

In the compilation process, for example, code optimization and conversion of code to assembly code may be performed.

Alternatively, the compilation process may refer to a process of converting source code directly into a machine language, and an executable program may be created directly through this process.

Assembly code, also referred to as an assembly language, is a language that is coded to correspond to a machine language with a strong association with instruction functions, instead of a machine language that is hard for users to understand.

Assembly code written through the compilation process may be written in a machine language by an assembler.

Machine code written in a machine language may be created as an object file, and the object file may be changed into an output file by a Linker.

Such a build process may be applied differently depending on the environment in which the process is performed. Bit padding, i.e., filling a blank that is an empty space in memory with bits, may occur or not depending on the environment in which the build process is performed.

The occurrence of bit padding may thus depend on the environment in which the program is performed, and bit padding may cause abnormal operation of the virtual controller. To solve this, the source code may be modified in advance.

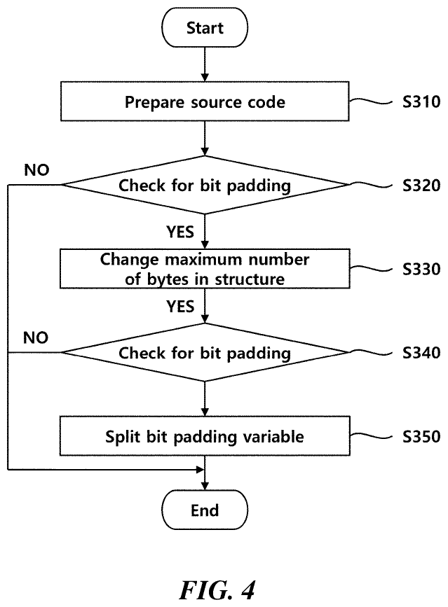

FIG. 3 is a view for explaining a method for solving a bit padding problem according to a first embodiment.

Referring to FIG. 3, the method for solving a bit padding problem according to the first embodiment may include a step or operation S210 of preparing source code, a step or operation S220 of checking for whether bit padding occurs, and a step or operation S230 of splitting a bit-padded variable.

The step or operation S210 of preparing source code may include preparing source code written in a variety of programming languages. Here, the source code may contain data on an actual controller (ECU), as well as data on a virtual controller (e.g., VECU).

The step or operation S220 of checking for whether bit padding occurs may include checking for whether bit padding occurs when compiling source code. In the step or operation S220 of checking for whether bit padding occurs, it is possible to check for bit padding by checking a structure included in the source code and variables included in the structure and checking the maximum number of bytes in a structure declaration. Also, it is possible to check for whether bit padding occurs by checking the maximum number of bits in the bit field.

The step or operation S230 of splitting a bit-padded variable may include splitting and declaring a variable causing bit padding among the variables included in the source code.

Moreover, when a bit field is a target to be processed, the step or operation S230 may include splitting and declaring bits causing bit padding among the bits included in the bit field in the source code.

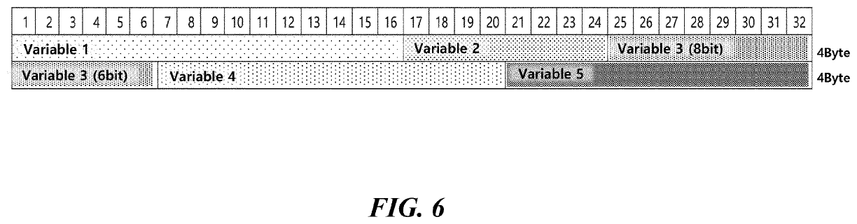

Here, splitting a bit padding variable may refer to splitting and declaring a variable so that there is no blank in memory. This is described in more detail below with reference to FIGS. 5-8.

Additionally, the method for solving a bit padding problem according to the first embodiment may further include a step or operation of compiling source code and creating a virtual controller.

Here, compiling of the source code may include converting source code into a machine language that can be understood by a computer or expressing source code in an assembly language. Also, the virtual controller may refer to a virtual model of an ECU (electronic controller unit).

The method for solving a bit padding problem according to this embodiment may be applied to a CAN DB (controller area network database). Also, as an example, the method for solving a bit padding problem according to this embodiment may be applied to a generator that generates a CAN DB in C code.

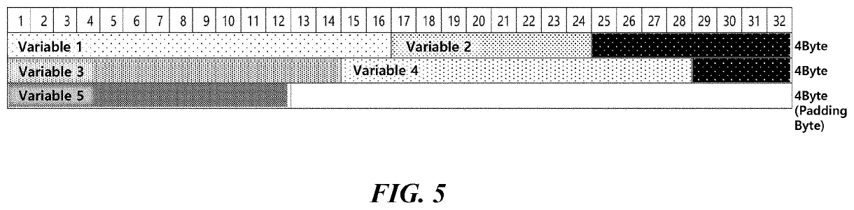

FIG. 4 is a view for explaining a method for solving a bit padding problem according to a second embodiment.

Referring to FIG. 4, the method for solving a bit padding problem according to the second embodiment may include a step or operation S310 of preparing source, a step or operation S320 of checking for whether bit padding occurs, a step or operation S330 of changing the maximum number of bytes in a structure, a step or operation S340 of checking for whether bit padding occurs, and a step or operation S350 of splitting a bit-padded variable. The step or operation S310 of preparing source code may include preparing source code written in a variety of programming languages. Here, the source code may contain data on an actual controller (ECU), as well as data on a virtual controller (vECU).

The step or operation S320 of checking for whether bit padding occurs may include checking for bit padding when compiling source code. In the step or operation S320 of checking for whether bit padding occurs, it is possible to check for whether bit padding occurs by checking a structure included in the source code and variables included in the structure and checking the maximum number of bytes in a structure declaration.

Also, it is possible to check for whether bit padding occurs by checking the maximum number of bytes in the bit field.

The step or operation S330 of changing the maximum number of bytes in a structure may also be referred to as a step or operation of changing the size of a structure.

The size of a structure may represent the overall size of the space a structure occupies in memory. In an example, the larger the size of the structure, the higher the values of variables placed consecutively in memory.

As an example, the step or operation S330 of changing the maximum number of bytes in a structure may include increasing the maximum number of bytes, which may mean increasing the size of a structure. Through this, the bit padding problem may be solved.

Moreover, the size of a structure may be decreased to prevent the occurrence of bit padding.

As an example, the size of a structure may be increased from 32 bits to 64 bits or decreased from 32 bits to 16 bits. In various embodiments, the size of a structure may be varied as required as long as bit padding can be avoided.

In addition, when processing a bit field, the step or operation of making a declaration so as to change the maximum number of bits in the bit field in the source code may be performed.

The step or operation S340 of checking for whether bit padding occurs may include re-checking for whether bit padding occurs, when compiling the source code in which the maximum number of bytes in a structure declaration is changed.

Also, it is possible to re-check for whether bit padding occurs by checking the maximum number of bits in the bit field.

Accordingly, the step or operation S340 may include checking for whether bit padding occurs, despite a change in the size of the structure.

The step or operation S350 of splitting a bit-padded variable include splitting and declaring a bit padding variable among the variables included in the source code.

Splitting a bit-padded variable may include splitting and declaring a variable so that there is no blank in memory. This is described in more detail below with reference to FIGS. 5-8.

Also, when a bit field is a target to be processed, splitting and declaring bits causing bit padding among the bits included in the bit field in the source code may be performed.

Additionally, the method for solving a bit padding problem according to the second embodiment may further include a step of compiling source code and creating a virtual controller.

Here, compiling may include converting source code into a machine language that can be understood by a computer or the step of expressing source code in an assembly language. Also, the virtual controller may refer to a virtual model of an ECU (electronic controller unit).

The method for solving a bit padding problem according to this embodiment may be applied to a CAN DB (controller area network database). Also, as an example, the method for solving a bit padding problem according to this embodiment may be applied to a generator that generates a CAN DB in C code.

FIGS. 5 and 6 are diagrams of an example for explaining bit padding according to an embodiment.

FIGS. 5 and 6 are diagrams of examples for explaining a case of splitting a variable to prevent bit padding that occurs in a structure of a 32 bit (4 byte) size.

Referring to FIGS. 5 and 6, one or more variables may be arranged in order in the structure. As an example, as illustrated in FIGS. 5 and 6, Variable 1 may have a size of 16 bits, Variable 2 may have a size of 8 bits, Variable 3 may have a size of 14 bits, Variable 4 may have a size of 12 bits, and Variable 5 may have a size of 12 bits. Also, Variables 1 to 5 may be arranged in order in the structure.

When variables 1 and 2 are allocated, an 8-bit storage space is left in the memory, and since Variable 3 to be declared next is 14 bits, the 8-bit blank may be padded with bits, and Variable 3 may be allocated to new memory. Next, when Variable 4 is declared, a 4-bit storage space is left in the memory. Since Variable 5 has a size of 12 bits, the 4-bit blank may be padded with bits, and Variable 5 may be allocated to new memory.

Variable 5 may thus be allocated to new memory, which may be called a padding byte.

In this case, the program may not be able to work properly due to bit padding.

Thus, Variable 3, which is a bit-padded variable, may be split—e.g., split and packed —to avoid a blank so that the bit padding does not occur. Accordingly, the program may work properly in any environment.

According to FIG. 6, Variable 3, which is a bit-padded variable, may be split into 8 bits and 6 bits and packed, and accordingly bit padding may not occur in the compilation process.

Moreover, when a bit field is a target to be processed, bit padding may be prevented by splitting and packing bits that cause bit padding.

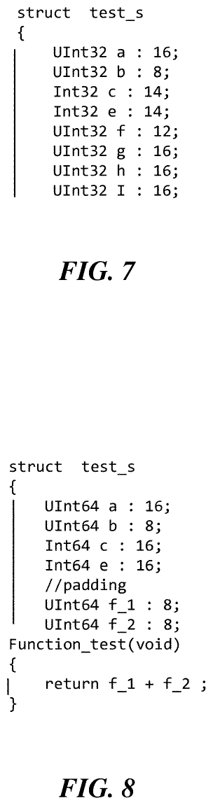

FIG. 7 is a diagram for explaining bit padding according to an embodiment. FIG. 8 is a diagram showing implementation of a method for solving a bit padding problem according to an embodiment.

Referring to FIG. 7, a structure named test_s contains Variables a, b, c, e, f, g, h, and i, and has a size of 4 bytes (32 bits).

Int and UInt represent the type of the variable. Int may denote an integer, and UInt may denote a non-negative integer, i.e., 0 and positive integers.

Variable a has a size of 16 bits, Variable b has a size of 8 bits, Variable c has a size of 14 bits, Variable e has a size of 14 bits, Variable f has a size of 12 bits, Variable g has a size of 16 bits, Variable h has a size of 16 bits, and Variable i has a size of 16 bits.

When these variables are arranged in order in a 32-bit structure, bit padding occurs. Thus, the method shown in FIG. 8 may be performed.

First, bit padding may be prevented by changing the size of the structure. While Variable c is a bit-padded variable in a 32-bit structure, bit padding caused by Variable c can be avoided by changing the size of the structure to 64 bits.

In this case, however, Variable f becomes a bit padding variable due to the change in the size of the structure. In this instance, bit padding may be prevented by splitting Variable f. As depicted in FIG. 8, Variable f may be split into Variable f_1 and Variable f_2, each having a size of 8 bits, and the two variables may be packed into one variable, thereby preventing bit padding.

Bit padding may thus be prevented by splitting and packing a bit-padded variable.

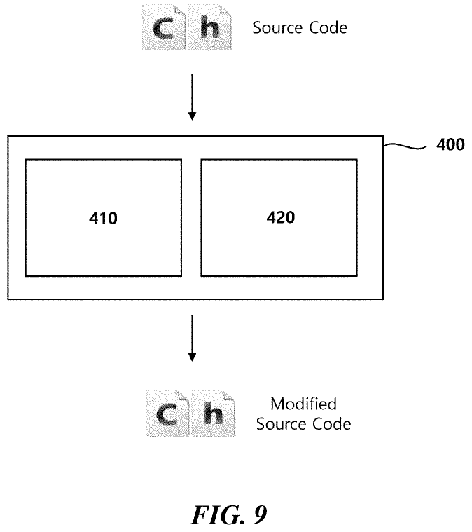

FIG. 9 is a view for explaining a processor performing a method for solving a bit padding problem according to an embodiment of the present disclosure.

Referring to FIG. 9, a processor 400 according to this embodiment may include a checking part 410 and a processing part 420.

The processor 400 may also be a central processing unit (CPU), and may perform arithmetic, controlling, execution, and input/output operations. In other words, the processor may be a crucial device used for a program or software to execute instructions and process data.

The checking part 410 may be a component the check for whether bit padding occurs. In an example, the checking part 410 may be a component that checks for whether bit padding occurs when compiling source code including a structure containing one or more variables.

The processing part 420 may be a component that modifies source code. In an example, when an occurrence of bit padding is verified, the processing part 420 may perform one or more of changing the maximum number of bytes in the structure and splitting a bit-padded variable among the one or more variables.

Here, splitting may refer to splitting the bit padding variable so that there is no blank in memory.

Also, the changing of the maximum number of bytes may involve increasing or decreasing the maximum number of bytes.

The processor 400 in this embodiment may perform the role of modifying source code such that bit padding does not occur when compiling the source code.

Additionally, the processor 400 according to this embodiment may perform the step of compiling the source code and creating a virtual controller.

Here, the compiling may refer to the step of converting source code into a machine language that can be understood by a computer or the step of representing source code in an assembly language. Also, the virtual controller may refer to a virtual model of an ECU (electronic controller unit).

The processor according to this embodiment may be applied to a CAN DB (controller area network database). Also, as an example, the processor according to this embodiment may be applied to a generator that generates a CAN DB in C code.

Terms such as “include”, “contain”, “comprise”, or “have” described above mean that the corresponding component may be present unless otherwise stated, and thus should be construed that the terms do not exclude other components, but may further include other components. All terms, including technical or scientific terms, have the same meaning as commonly understood by those having ordinary skill in the art to which the present disclosure pertains, unless defined otherwise. Generally used terms, such as terms defined in the dictionary, should be interpreted as being consistent with the contextual meaning of the related art, and should not be interpreted in an ideal or excessively formal meaning unless explicitly defined in the present disclosure.

The above description is merely illustrative of the technical idea of the present disclosure, and those having ordinary skill in the art to which the present disclosure pertains may perform various modification and changes within the scope not departing from the essential characteristics of the present disclosure. Accordingly, the embodiments described in the present disclosure are not intended to limit, but to explain the technical idea of the present disclosure, and the scope of the technical spirit of the present disclosure is not limited by these embodiments. The scope of protection of the present disclosure should be interpreted by the claims below, and all technical spirits within the scope equivalent to the scope of the claims should be interpreted as being included in the scope of the claims of the present disclosure.

What is claimed is:

1. A method comprising:
checking for whether bit padding occurs when compiling source code including a structure containing one or more variables; and
when an occurrence of bit padding is verified, splitting a bit-padded variable in the source code.

2. The method of claim 1, wherein splitting the bit-padded variable includes splitting the bit-padded variable so that there is no blank in memory.

3. The method of claim 1, wherein the split bit-padded variable is packed into one variable.

4. The method of claim 1, further comprising compiling and linking the source code, subjected to splitting, and creating a virtual controller.

5. The method of claim 4, wherein the virtual controller is a virtual model of an electronic controller unit (ECU).

6. A method comprising:
when bit padding occurs during compiling source code including a structure containing one or more variables, changing a maximum number of bytes in the structure; and
when bit padding occurs in the source code in which the maximum number of bytes in the structure has been changed, splitting a bit-padded variable in the source code in which the maximum number of bytes in the structure has been changed.

7. The method of claim 6, wherein splitting the bit-padded variable includes splitting the bit-padded variable so that there is no blank in memory.

8. The method of claim 6, further comprising compiling and linking the source code, subjected to splitting, and creating a virtual controller.

9. The method of claim 8, wherein the virtual controller is a virtual model of an electronic controller unit (ECU).

10. The method of claim 6, wherein changing the maximum number of bytes includes increasing the maximum number of bytes.

11. The method of claim 6, wherein the split bit-padded variable is packed into one variable.

12. A processor comprising:
a checking part configured to check for whether bit padding occurs when compiling source code including a structure containing one or more variables; and
a processing part configured to perform one or more of changing a maximum number of bytes in the structure or splitting a bit-padded variable among the one or more variables when an occurrence of bit padding is verified by the checking part.

13. The processor of claim 12, wherein the processing part is configured to split the bit-padded variable so that there is no blank in memory.

14. The processor of claim 12, wherein the processing part is configured to change the maximum number of bytes by increasing the maximum number of bytes.

15. A method comprising:
checking for whether bit padding occurs when compiling source code including one or more bit field declarations; and
when an occurrence of bit padding is verified, splitting bits where bit padding occurs in the bit field.

16. The method of claim 15, wherein splitting the bits includes splitting a bit-padded variable so that there is no blank in memory.

17. The method of claim 16, wherein the split bit-padded variable is packed into one variable.

18. The method of claim 15, further comprising compiling and linking the source code, subjected to splitting, and creating a virtual controller.

19. The method of claim 18, wherein the virtual controller is a virtual model of an electronic controller unit (ECU).
